(19) United States
(12) Patent Application Publication
(10) Pub. No.: US 2015/0302412 A1
(43) Pub. Date: Oct. 22, 2015

(54) ONLINE BANK TRANSFER TRANSACTIONS

(71) Applicant: GOOGLE INC., Mountain View, CA (US)

(72) Inventor: Hemant Madhav Bhanoo, Palo Alto, CA (US)

(21) Appl. No.: 14/689,776

(22) Filed: Apr. 17, 2015

Related U.S. Application Data
(60) Provisional application No. 61/981,175, filed on Apr. 17, 2014.

(51) Int. Cl. G06Q 20/40; G06Q 20/24

(52) U.S. Cl. CPC G06Q 20/4016; G06Q 40/02; G06Q 20/24

(57) ABSTRACT

A user establishes an account with a payment processing system and enters financial account information and credit account information. The user initiates a transaction with a merchant system for a payment amount and selects to pay with the financial account. The payment processing system requests and receives a credit authorization for the payment amount from an issuer system associated with the credit account and initiates a bank transfer, requesting funds from the user's financial account equal to the payment amount or the payment amount minus a minimal amount. The payment processing system credits an account associated with the merchant system and transmits a transaction approval to the merchant system. The payment processing system receives the bank transfer and transmits a request to the issuer system to cancel the credit authorization, waits for the credit authorization to expire, or charges the minimal amount on the user credit account.

### RELATED APPLICATION

This patent application claims priority to U.S. Patent Application Ser. No. 61/981,175, filed Apr. 17, 2014 and entitled “Online Bank Transfer Transactions.” The entire contents of the above-identified application are hereby fully incorporated herein by reference.

### TECHNICAL FIELD

The present disclosure relates generally to decreasing the risk associated with online bank transfer transactions by using credit authorizations to guarantee bank transfer transactions.

### BACKGROUND

When processing credit account payments with a credit card system, the credit card transaction comprises a credit authorization and a credit charge. The credit authorization is requested by a merchant system to guarantee that the credit card user has enough credit on his account to pay for the transaction. After the credit authorization is granted, the merchant system may, within a certain timeframe, request the credit charge from the credit card system. At this point, the user credit account is charged by the credit card system, and the merchant system awaits payment from the credit card system. Typically, credit card systems charge a fixed fee to the merchant system when granting a credit authorization and, when the credit charge is entered, a variable fee that is a percentage of the transaction amount. The variable fee can be substantial, depending on the transaction amount. This process leads to high transaction costs for the merchant system that may also be passed on to the credit card user by the merchant system, raising the prices of the products or services sold.

An alternative payment method to a credit card transaction is a bank transfer from the customer account to the merchant system account. The bank transfer generally requires a few days for approval from a financial account system. The merchant system takes a risk in providing products or rendering services to a customer with no assurance that the bank transfer will be approved.

### SUMMARY

In certain example aspects described herein, computer-implemented methods to use a credit authorization to guarantee a bank transfer are provided. In an example embodiment, a user establishes an account with a payment processing system and enters financial account information and credit account information. The user initiates a transaction with a merchant system for a payment amount and selects to pay with the financial account. The payment processing system requests and receives a credit authorization for the payment amount from an issuer system associated with the credit account and initiates a bank transfer, requesting funds from the user's financial account. The payment processing system credits an account associated with the merchant system and transmits a transaction approval to the merchant system. The payment processing system receives the bank transfer and transmits a request to the issuer system to cancel the credit authorization, or charges a minimal amount on the user credit account and refunds the user on the credit account for the minimal amount charged.

In certain other example aspects described herein, systems and computer program products to use a credit authorization to guarantee a bank transfer are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for using a credit authorization to guarantee a bank transfer transaction, in accordance with certain example embodiments.

FIG. 2 is a block flow diagram depicting a method for using a credit authorization to guarantee a bank transfer transaction, in accordance with certain example embodiments.

FIG. 3 is a block flow diagram depicting a method for registering a user account with a payment processing system, in accordance with certain example embodiments.

FIG. 4 is a block flow diagram depicting a method for initiating a transaction with a merchant system, in accordance with certain example embodiments.

FIG. 5 is a block flow diagram depicting a method for receiving a payment authorization, in accordance with certain example embodiments.

FIG. 6 is a block flow diagram depicting a method for processing a transaction, in accordance with certain example embodiments.

FIG. 7 is a block flow diagram depicting an alternate method for processing a transaction, in accordance with certain example embodiments.

FIG. 8 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques for using a credit authorization to guarantee a bank transfer transaction. In an example embodiment, a user establishes an account with a payment processing system and enters financial account information and credit account information. The user initiates a transaction with a merchant system for a payment amount and selects to pay with the financial account. The payment processing system requests and receives a credit authorization for the payment amount from an issuer system associated with the credit account. The payment processing system initiates a bank transfer, requesting funds from the user's financial account. The payment processing system credits an account associated with the merchant system and transmits a transaction approval to the merchant system. The payment processing system receives the bank transfer and transmits a request to the issuer system to cancel the credit authorization or charges a minimal amount on the user credit account and requests a refund to the user on the credit account for the minimal amount charged. In other example embodiments, the payment processing system does not receive the bank transfer before a threshold time period has elapsed and charges the payment amount on the user credit account.

In an example embodiment, the user establishes an account with the payment processing system and downloads a payment application associated with the payment processing system onto a user computing device. For example, the user downloads a digital wallet application module that communicates with the payment processing system. The user enters financial account information and credit account information into the user account via the user computing device. The user accesses a merchant system website, selects one or more products for purchase on the website, and indicates readiness for payment. In an example embodiment, the merchant system displays payment options and the user selects to pay using the digital wallet. The user further selects to pay using the financial account.

In an example embodiment, the payment processing system transmits a credit authorization request for the payment amount of the transaction to the issuer system associated with the user credit account. The issuer system approves the credit authorization request. In other example embodiments, the issuer system does not approve the credit authorization and the payment processing system or merchant system cancels the transaction. If the credit authorization request is approved, the payment processing system provides a transaction authorization to the merchant system and credits the merchant system account. For example, the payment processing system notifies the merchant system that the transaction may proceed and that the merchant system may provide to the user products or services associated with the transaction and the payment processing system transfers funds equal to the payment amount to an account associated with the merchant system. The payment processing system initiates a bank transfer with a financial account system associated with the user financial account.

In an example embodiment, the payment processing system receives the bank transfer from the financial account system and transmits a credit authorization cancellation request to the issuer system, which cancels the credit authorization. In another example embodiment, the payment processing system receives the bank transfer from the financial account system and allows the credit authorization to expire. In yet another example embodiment, the payment processing system receives the bank transfer from the financial account system and transmits a payment request to the issuer system for a minimal amount. In this example embodiment, the issuer system charges the minimal amount to the user credit account and the payment processing system initiates a refund with the issuer system and/or acquirer system to refund the user for the minimal amount charged to the credit account. In other example embodiments, the payment processing system does not receive the bank transfer and completes the credit card transaction. For example, the payment processing system transmits a payment request to the issuer system and the payment amount of the transaction is charged to the user credit account.

By using and relying on the methods and systems described herein, a payment processing system guarantees reimbursement for a bank transfer transaction by requesting and receiving a credit authorization from an issuer system associated with a credit account of a user. As such, the systems and methods described herein may provide a guarantee to the payment processing system that, in the event that the bank transfer transaction is not approved, the payment processing system can receive reimbursement via a credit card transaction for which a credit authorization has been received.

### Example System Architecture

Turning now to the drawings, in which like numerals indicate like (but not necessarily identical) elements throughout the figures, example embodiments are described in detail.

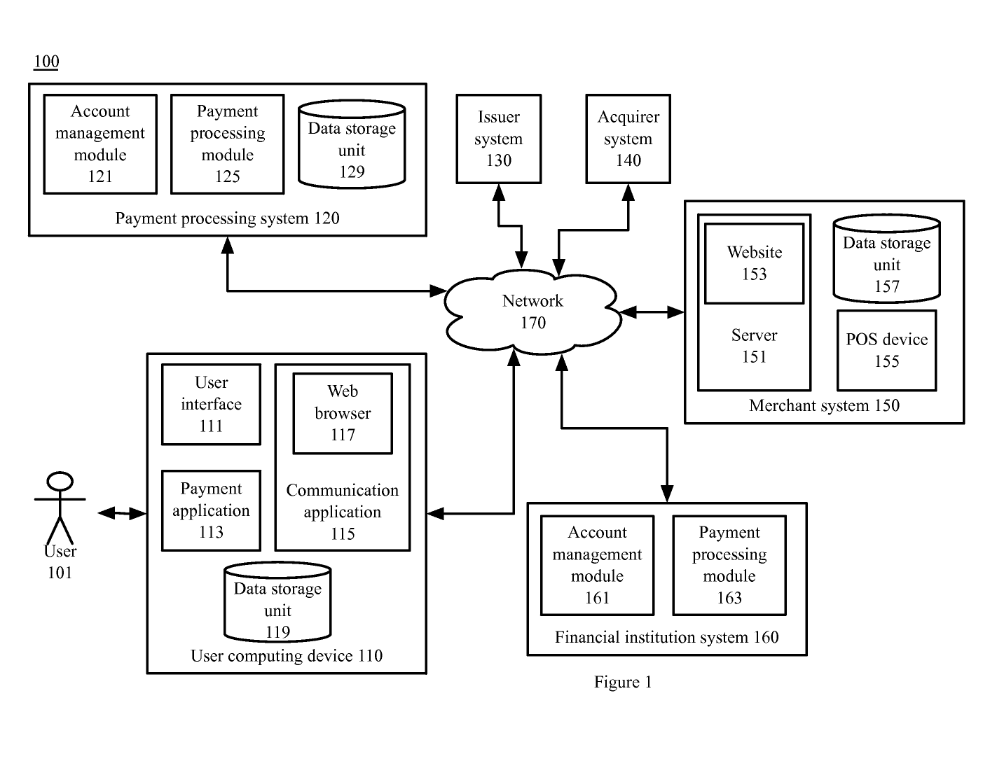

FIG. 1 is a block diagram depicting a system 100 for using a credit authorization to guarantee a bank transfer transaction, in accordance with certain example embodiments. As depicted in FIG. 1, the system 100 includes network computing devices 110, 120, 130, 140, 150, and 160 that are configured to communicate with one another via one or more networks 170. In some embodiments, a user 101 associated with a device must install an application and/or make a feature selection to obtain the benefits of the techniques described herein.

For example, the network 170 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 120, 130, 140, 150, and 160 includes a device having a communication module capable of transmitting and receiving data over the network 170. For example, each network computing device 110, 120, 130, 140, 150, and 160 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 120, 130, 140, 150, and 160 are operated by users 101, payment processing system operators, issuer system operators, acquirer system operators, merchant system operators, and financial institution system operators, respectively.

An example user computing device 110 comprises a user interface 111, a payment application 113, a communication application 115, a web browser 117, and a data storage unit 119. In an example embodiment, the user interface 111 enables a user 101 to interact with the payment application 113, the data storage unit 119 and/or web browser 117. In an example embodiment, the user 101 interacts with the payment application 113 via the user interface 111. In an example embodiment, the user 101 enters payment information into a digital wallet account via the user interface 111. In an example embodiment, the user 101 selects payment options by actuating a user interface 111 object. For example, the user 101 selects user interface 111 objects to pay with the digital wallet and the user 101 financial account.

In an example embodiment, the payment application 113 is a program, function, routine, applet, or similar entity that exists on and performs its operations on the user computing device 110. In certain embodiments, the user 101 must install the payment application 113 and/or make a feature selection on the user computing device 110 to obtain the benefits of the techniques described herein. In an example embodiment, the user 101 may access the payment application 113 on the user computing device 110 via a user interface 111. In another example embodiment, the user accesses the payment application 113 through the web browser 117 or other suitable means of access. In an example embodiment, the payment application 113 is an application that requires the user 101 to sign in or in any other suitable manner to log in. In an example embodiment, the payment application 113 is associated with the payment processing system 120. In an example embodiment, the user 101 accesses an application distribution site and downloads the payment application 113 onto the user computing device 110. In an example embodiment, the payment application 113 enables the user 101 to sign in to and access a user account managed by the payment processing system 120. In this example embodiment, the user account may comprise a digital wallet account. In an example embodiment, the payment application 113 enables the user 101 to enter payment information into the digital wallet account.

In an example embodiment, the user 101 can use a communication application 115, such as a web browser 117 application or a stand-alone payment application 113, to view, download, upload, or otherwise access documents or web pages via a distributed network 170.

In an example embodiment, the communication application 115 can interact with web servers or other computing devices connected to the network 170, including the user computing device 110, a web server (not depicted) of the payment processing system 120, a web server 131 of the merchant system 150, and a web server (not depicted) of the financial institution system 160.

In an example embodiment, the web browser 117 can enable the user 101 to interact with web pages using the user computing device 110. In an example embodiment, the web browser 114 enables the user 101 to access and/or sign in to the user's payment processing system 120 account. In an example embodiment, the user 101 may access websites of the payment processing system 120, merchant system 150, or financial institution system 160 via the web browser 117.

In an example embodiment, the data storage unit 119 comprises any local or remote data storage structure accessible to the user computing device 110 suitable for storing information. In an example embodiment, the data storage unit 119 stores encrypted information, such as HTML5 local storage. In an example embodiment, the data storage unit 119 stores user 101 financial account information or credit account information accessible by the payment application 113.

An example payment processing system 120 comprises an account management module 121, a payment processing module 125, and a data storage unit 129. In an example embodiment, the user 101 has an account with the payment processing system 120. In an example embodiment, the account management module 121 manages the user's 101 account. For example, the account management module 121 may receive a user's 101 username and password and allow the user 101 to access services provided by the payment processing system 120. In an example embodiment, the account management module 121 communicates with the payment application 113 resident on the user computing device 110. In another example embodiment, the account management module 121 communicates with the user 101 via the user computing device web browser 117. In an example embodiment, the account management module 121 manages the user's 101 digital wallet account. In this example embodiment, the account management module 121 may communicate with a digital wallet payment application 113 resident on the user computing device 110 via the network 170.

In an example embodiment, the payment processing module 125 communicates with the financial institution system 160, the merchant system 150, the issuer system 130, and/or the acquirer system 140 to process payments. In an example embodiment, the payment processing module 125 retrieves user 101 financial account information and credit account information from the account management module 121, from the data storage unit 129, or by communicating with the payment application 113 over the network 170. In an example embodiment, the payment processing module 125 requests a credit authorization from the issuer system 130 through the acquirer system 140 and receives the credit authorization. In an example embodiment, the payment processing module 125 initiates a bank transfer with the financial institution system 160. In an example embodiment, the payment processing module 125 receives the bank transfer or completes the credit card transaction associated with the credit card authorization. In an example embodiment, the payment processing module 125, upon receiving the bank transfer from the financial institution system 160, either requests a cancellation of the credit authorization from the issuer system 130 or completes the credit card transaction for a minimal charge amount and then initiates a refund of the charge amount via a credit account refund transaction. In an example embodiment, the payment processing module 125 generates a receipt of the transaction and transmits the receipt to the user computing device 110.

In an example embodiment, the data storage unit 129 comprises any local or remote data storage structure accessible to the payment processing system 120 suitable for storing information. In an example embodiment, the data storage unit 129 stores encrypted information, such as HTML5 local storage. In an example embodiment, the data storage unit 129 stores user 101 financial account information and/or user 101 credit account information.

In an example embodiment, the issuer system 130 approves or denies a credit authorization requested by the payment processing system 120. In an example embodiment, the issuer system 130 communicates with the acquirer system 140 to approve a credit authorization and to make payment to the payment processing system 120 and/or merchant system 150. For example, the acquirer is a third party payment processing company.

An example merchant system 150 comprises a server 151, a website 153, a POS terminal 155, and a data storage unit 157. In an example embodiment, the merchant system 150 communicates with the user computing device 110 and the payment processing system 120.

In an example embodiment, the server 151 provides the content accessible by the user 101 through the web browser 117 and/or merchant application (not shown) resident on the user computing device 110, including but not limited to html documents, images, style sheets, and scripts. In an example embodiment, the server 151 supports the merchant system 150 website 153.

In an example embodiment, the website 153 is a means by which the user 101 selects one or more products or services for purchase and initiates a transaction with the merchant system 150. In an example embodiment, the user 101 accesses the website 153 via the web browser 117. In another example embodiment, the user 101 accesses the website 153 via a merchant system 150 application (not shown) resident on the user computing device 110.

In an example embodiment, the POS terminal 155 is capable of processing a purchase transaction initiated by a user 101. For example, the POS terminal 155 is a cash register. In an example embodiment, the merchant system 150 operates a commercial store and the user 101 indicates a desire to make a purchase by presenting a form of payment at the merchant POS terminal 155 terminal. In an example embodiment, the merchant POS terminal 155 is capable of communicating with the user computing device 110 using an NFC, Bluetooth, and/or Wi-Fi communication method.

In an example embodiment, the data storage unit 157 comprises any local or remote data storage structure accessible to the merchant system 150 suitable for storing information. In an example embodiment, the data storage unit 157 stores encrypted information, such as HTML5 local storage.

An example financial institution system 160 comprises an account management module 161 and a payment processing module 163. In an example embodiment, the financial institution system 160 communicates with the payment processing system 120 and/or the user computing device 110.

In an example embodiment, the account management module 161 manages a user 101 financial account. In an example embodiment, the account management module 161 generates a statement or receipt comprising transaction details accessible by the user 101 via the user computing device 110.

In an example embodiment, the payment processing module 163 communicates over the network 170 to response to a bank transfer request by the payment processing system 120. In an example embodiment, the payment processing module 163 participates in the transfer of funds from the user 101 financial account to the payment processing system 120 account or merchant system 150 account.

It will be appreciated that the network connections shown are example and other means of establishing a communications link between the computers and devices can be used. Moreover, those having ordinary skill in the art having the benefit of the present disclosure will appreciate that the user computing device 110, the payment processing system 120, the merchant system 150, and the financial institution system 160 illustrated in FIG. 1 can have any of several other suitable computer system configurations. For example, a user computing device 110 embodied as a mobile phone or handheld computer may or may not include all the components described above.

### Example Processes

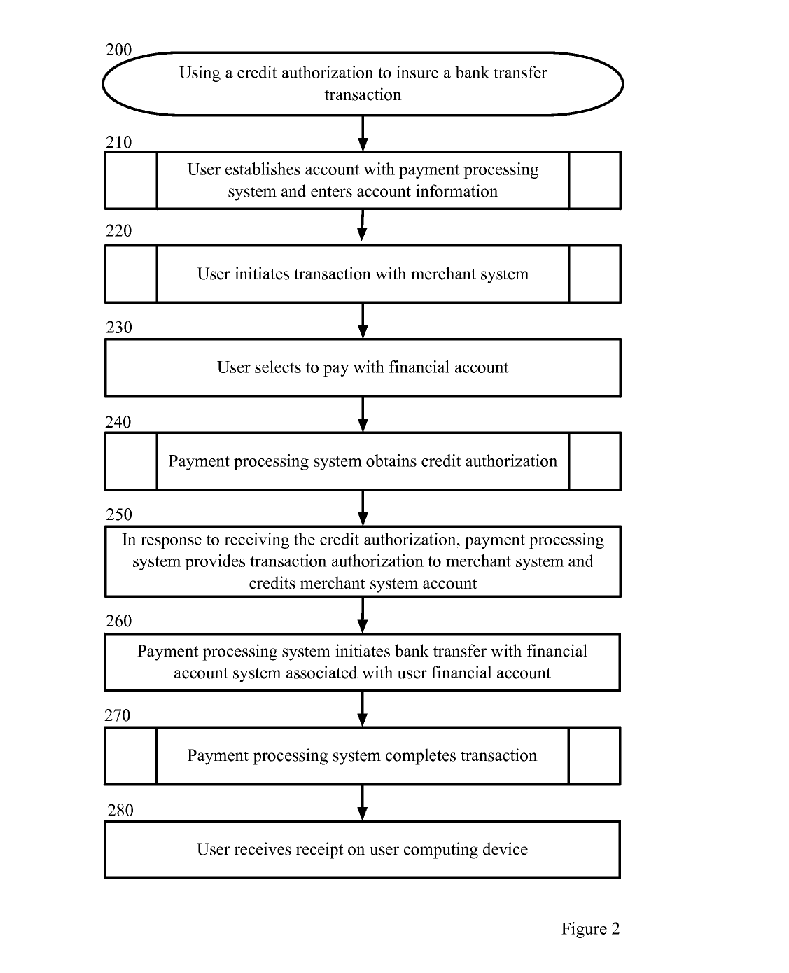

The example methods illustrated in FIGS. 2-7 are described hereinafter with respect to the components of the example operating environment 100. The example methods of FIGS. 2-7 may also be performed with other systems and in other environments.

FIG. 2 is a block diagram depicting a method 200 for using a credit authorization to guarantee a bank transfer transaction, in accordance with certain example embodiments. The method 200 is described with reference to the components illustrated in FIG. 1.

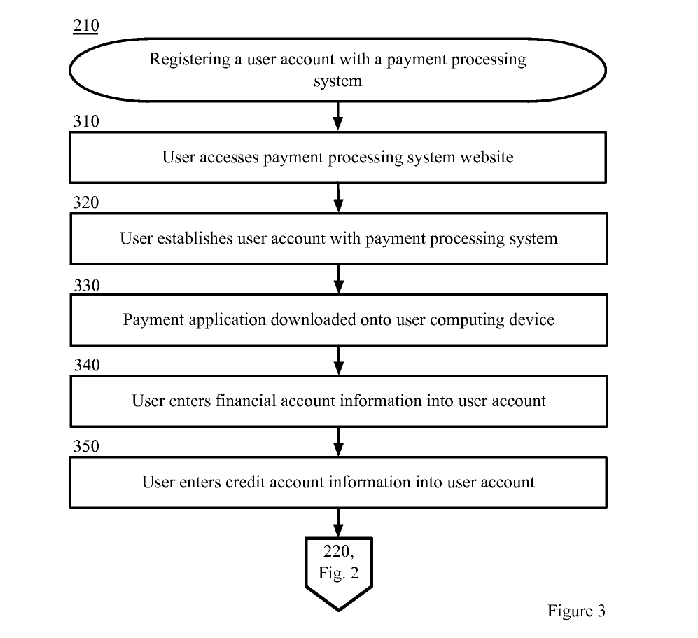

In block 210, the user 101 establishes an account with the payment processing system 120 and enters account information. The method 210 for registering a user account with a payment processing system 120 is described in more detail hereinafter with reference to the method 210 described in FIG. 3.

FIG. 3 is a block flow diagram depicting a method 210 for registering a user account with a payment processing system 120, in accordance with certain example embodiments, as referenced in block 210. The method 210 is described with reference to the components illustrated in FIG. 1.

In block 310, the user 101 accesses the payment processing system 120 website. In an example embodiment, the user 101 accesses the payment processing system 120 website via the web browser 117 of the user computing device 110. For example, the user 101 enters the website address in the address bar of the web browser 117 to access the website. In another example embodiment, the user 101 accesses the payment processing system 120 website using an application resident on the user computing device 110. For example, the user 101 selects an application on the user computing device 110 that connects the user 101 to the payment processing system 120 website.

In block 320, the user 101 establishes a user account with the payment processing system 120. In an example embodiment, the user 101 registers a username and a password associated with the user account to use to sign in to the user account. In an example embodiment, the user account is associated with a service, such as a digital wallet, an email service, a messaging service, a gaming service, or a mapping service. In another example embodiment, the user account is associated with multiple services.

In block 330, the payment application 113 is downloaded onto the user computing device 110. In an example embodiment, the payment application 113 communicates with the payment processing system 120 over the network 170. In an example embodiment, the payment application 113 is associated with the user account and may be utilized by the user 101 to access the user account and/or services provided by the payment processing system 120 for the user 101 associated with the user account. For example, the payment application 113 may be a digital wallet application module to which the user 101 may upload financial data. In this example, the digital wallet payment application 113 communicates with the payment processing system 120, which administers the user digital wallet account. In another example embodiment, the user 101 may download various applications associated with the user account from the payment processing system 120. In another example embodiment, the payment application 113 is downloaded onto the user computing device 110 before the user 101 establishes the user account with the payment processing system 120. In certain example embodiments, the user 101 does not download the payment application 113 onto the user computing device 110.

In block 340, the user 101 enters financial account information into the user account. In an example embodiment, the financial account information is associated with a financial institution system 160. In an example embodiment, the financial institution system 160 is a bank or a credit union with which the user 101 has a financial account. In an example embodiment, financial account information comprises an account number, a routing number, the name associated with the financial account, the address associated with the financial account and/or any other relevant, useful, or necessary information that the user 101 may enter into the user account or that the user account may require. In an example embodiment, the user 101 enters the financial account information using the payment application 113. For example, the payment application 113 is a digital wallet application module that communicates with a digital wallet account managed by the payment processing system 120. In another example embodiment, the user 101 enters the financial account information via the web browser 117, which communicates with the payment processing system 120.

In block 350, the user 101 enters credit account information into the user 101 account. In an example embodiment, the credit account is associated with an issuer system 130 and an acquirer system 140. In an example embodiment, the credit account information comprises a credit card number, an expiration date, a card verification number, the name associated with the credit account, and/or any other relevant, useful, or necessary information that the user 101 may enter into the user account or that the user account may require. In an example embodiment, the user 101 enters the credit account information using the payment application 113, which communicates with the payment processing system 120. In another example embodiment, the user 101 enters the financial account information via the web browser 117, which communicates with the payment processing system 120.

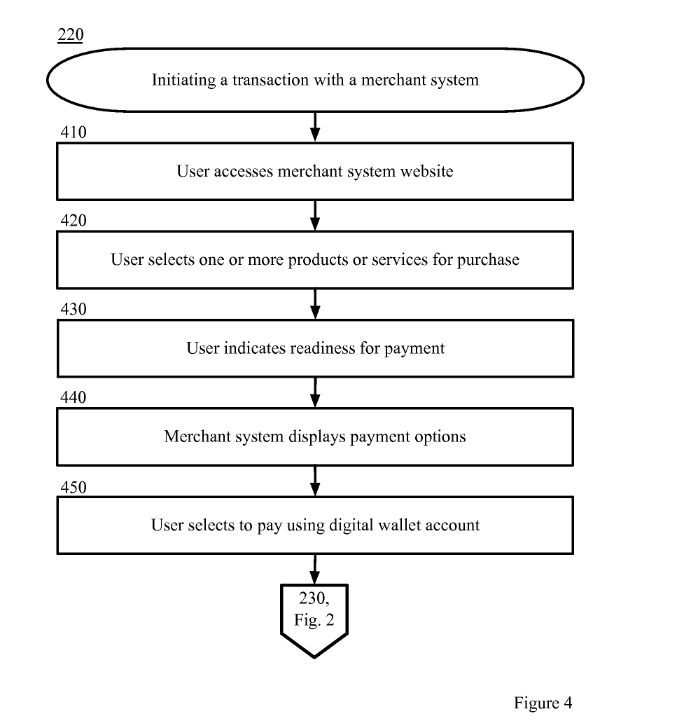

Returning to FIG. 2, in block 220, the user 101 initiates a transaction with the merchant system 150. The method 220 for initiating a transaction with a merchant system 150 is described in more detail hereinafter with reference to the method 220 described in FIG. 4.

FIG. 4 is a block flow diagram depicting a method 220 for initiating a transaction with a merchant system 150, in accordance with certain example embodiments, as referenced in block 220. The method 220 is described with reference to the components illustrated in FIG. 1.

In block 410, the user 101 accesses a merchant website 153. In an example embodiment, the user 101 enters the merchant website 153 address into the web browser 117 or otherwise accesses the merchant website 153 via the web browser 117. In an example, the user 101 actuates a user interface 111 object on a merchant system 150 advertisement on the web browser 117 and the web browser 117 redirects to the merchant website 153. In another example embodiment, the user 101 accesses the merchant system 150 via a merchant system 150 application (not shown) resident on the user computing device 110 that communicates with the merchant system 150. For example, the user 101 downloads the merchant system 150 application from the merchant system 150. In other example embodiments, the user 101, instead of accessing a merchant website 153, makes a purchase via a merchant POS terminal 155 at a merchant system 150 location.

In block 420, the user 101 selects one or more products or services for purchase. For example, the user 101 selects one or more products or services on the website 153 and adds them to a virtual shopping cart. In another example, the user 101 gathers one or more products or services for purchase at a physical location of the merchant system 150.

In block 430, the user 101 indicates readiness for payment. For example, the user 101 actuates an object on a user interface 111 to select an option to checkout. In an example embodiment, the user 101 enters additional information, such as shipping information, associated with the order. In another example, the user 101 presents at a merchant POS terminal 155 one or more products or services that the user 101 desires to purchase.

In block 440, the merchant system 150 displays payment options. In an example embodiment, the merchant system website 153 displays payment options that may comprise payments via credit card, financial account, digital wallet, stored value card, and/or coupon. In an example embodiment, the merchant website 153 presents one or more user interface 111 objects that the user 101 may actualize via the user computing device 110 to select a payment option. In another example embodiment, a merchant POS terminal 155 operator and/or the user interface of the merchant POS terminal 155 may describe or display the various acceptable payment options available to the user 101 for the transaction.

In block 450, the user 101 selects to pay using a digital wallet account. In an example embodiment, the digital wallet account is associated with the payment processing system 120. In an example embodiment, the user account with the payment processing system 120 comprises the digital wallet account. In an example embodiment, the payment application 113 is a digital wallet application module that communicates with the payment processing system 120. In an example embodiment, the user 101 actuates a user interface 111 object to select the digital wallet payment option. In certain example embodiments, the user 101 may need to sign in to the user account and/or digital wallet account to continue with the transaction. For example, the payment application 113 requests a username and password associated with the user account. In another example, the user computing device web browser 117 is redirected to a payment processing system 120 website, wherein the user 101 enters a username and password associated with the user account. In yet another example, wherein the user 101 is transacting at a merchant POS terminal 155, the user 101 accesses the payment application 113 on the user computing device 110 and taps the phone to a near field communication (“NFC”) enabled, Bluetooth-enabled, or Wi-Fi enabled POS terminal 155 terminal. In this example, a network 170 connection is established between the user computing device 110 and the merchant POS terminal 155. In an example embodiment, the merchant system 150 transmits a payment request to the payment application 113 or to the payment processing system for the payment amount of the transaction.

From block 450, the method 220 returns to block 230 in FIG. 2.

Returning to FIG. 2, in block 230, the user 101 selects to pay with the financial account. In an example embodiment, the user 101 actuates a user interface 111 object on the user computing device 110 to select to pay with the financial account. In an example, the digital wallet application module, in response to the user 101 selecting to pay using the digital wallet, opens on the user computing device 110, presents payment options to the user 101, and the user 101 selects to pay with the financial account. In an example embodiment, the financial account is a checking account associated with the financial institution system 160. In another example embodiment, the user 101 configures the digital wallet settings to establish rules that determine the order to apply financial accounts to a transaction. For example, the digital wallet account comprises a first user 101 financial account and a second user 101 financial account and the user 101 configures the account settings so that the first user 101 financial account is applied first to any transaction payment requests received from a merchant system 150.

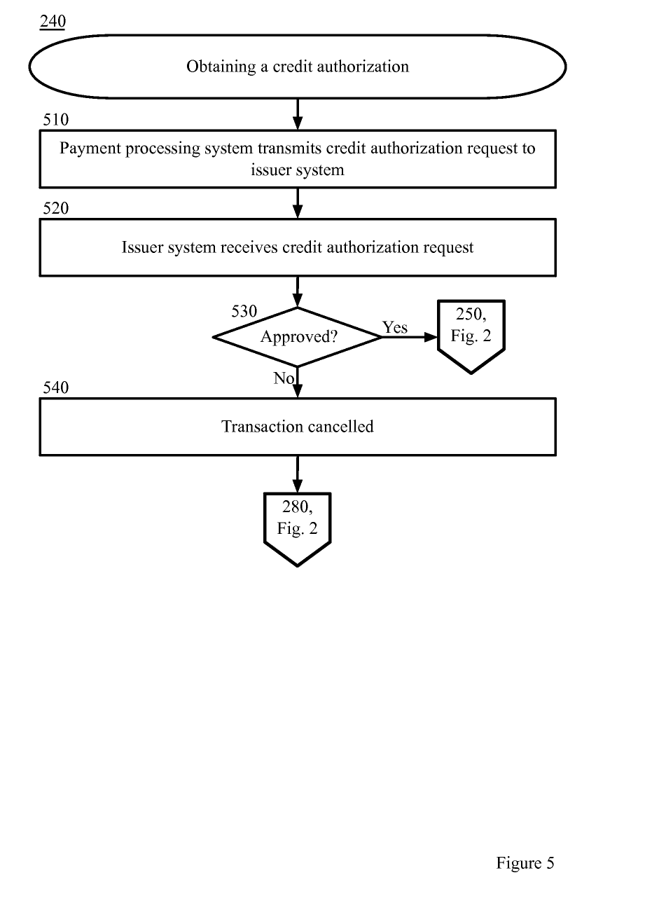

In block 240, the payment processing system 120 obtains a credit authorization. The method 240 for obtaining a credit authorization is described in more detail hereinafter with reference to the method 240 described in FIG. 5.

FIG. 5 is a block flow diagram depicting a method 240 for obtaining a credit authorization, in accordance with certain example embodiments, as referenced in block 240. The method 240 is described with reference to the components illustrated in FIG. 1.

In block 510, the payment processing system 120 transmits a credit authorization request to the issuer system 130. In an example embodiment, the user 101 first selects a credit account for which the payment processing system 120 will request a credit authorization. For example, when the user 101 selects a financial account from which to request payment on the digital wallet account module, the user 101 also selects a credit account from which to request a credit authorization to secure the transaction. The payment processing system 120 notifies the user 101 that a credit authorization will be requested to guarantee payment via the financial account. In an example embodiment, the user 101 consents or does not consent to the payment processing system 120 requesting the credit authorization. For example, the user 101 does not consent to the credit authorization request and the transaction is cancelled. In another example, the user 101 consents to the credit authorization request and the payment processing system 120 proceeds to transmit a credit authorization request to the issuer system 130 associated with the user 101 credit account. The payment processing system 120 identifies the user's saved credit account information and transmits the credit authorization request for the payment amount to the issuer system 130 associated with the user's saved credit account information. In an example embodiment, the user 101 has more than one saved credit account and the user 101 selects a credit account or the payment processing system 120 selects a credit account according to user-configured rules or default rules. In this embodiment, the payment processing system 120 transmits a credit authorization request to the issuer system 130 associated with the selected credit account.

A credit authorization request may comprise an account number, a name associated with the credit account, an expiration date of the payment instrument (for example, a credit card) associated with credit account, a verification number (for example, a CVV), and/or other credit account information and/or other verification information. In an example embodiment, the credit authorization request is transmitted to an acquirer system 140, which forwards the credit authorization request to the issuer system 130.

In block 520, the issuer system 130 receives the credit authorization request. For example, the issuer system 130 receives the credit authorization request over the network 170 from the acquirer system 140.

In block 530, the issuer system 130 approves or denies the credit authorization request. In an example embodiment, the user 101 has a credit limit associated with the credit account over which the user 101 may not charge. In this example embodiment, the issuer system 130 bases the credit authorization decision on the credit limit and the user's 101 current balance. The issuer system 130 may also look at the user's 101 credit account payment history, credit score, or other indicators to determine whether to approve or deny the credit authorization request. The issuer system 130 may also verify the user 101 name associated with the credit account, the expiration date of the payment instrument, the verification number and other verification information to guarantee that the credit authorization request is not fraudulent.

If the issuer system 130 denies the credit authorization request, the method 240 proceeds to block 540.

In block 540, the transaction is cancelled. In an example embodiment, the payment processing system 120 notifies the merchant system 130 and the user 101 via the user computing device 110 that the payment processing system 120 is unable to process the transaction. In an example embodiment, this notification is routed through the acquirer system 140. In another example embodiment, the payment processing system 120 attempts a credit authorization request to an issuer system 130 associated with a second or subsequent user 101 credit account. For example, the user 101 has multiple credit card accounts saved in the digital wallet account associated with the payment processing system 120. In yet another example embodiment, the user 101 may select another payment option to complete the transaction.

The method 240 then proceeds to block 280 in FIG. 2. For example, the user 101 receives notification via the user computing device 110 that the payment processing system 120 could not process the financial account transaction. In this example, the user 101 may be notified of any reasons why the financial account transaction could not be processed. For example, the user 101 is notified that a credit authorization is required and that the payment processing system 120 failed to obtain a credit authorization from the issuer system 130 associated with the user 101 credit account.

Returning to block 530, if the issuer system 130 approves the credit authorization request, the method 240 proceeds to block 250 in FIG. 2. In an example embodiment, the issuer system 130 transmits an authorization code to the acquirer system 140, the acquirer system 140 authorizes the transaction, and the acquirer system 140 notifies the payment processing system 120 of the authorization.

Returning to FIG. 2, in block 250, the payment processing system 120, in response to receiving the credit authorization, provides a transaction authorization to the merchant system 150 and credits the merchant system 150 account. For example, in response to receiving the credit authorization, the payment processing system 120 provides a transaction authorization to the merchant to the merchant system 150 and credits the merchant system 150 account. In this example embodiment, the payment processing system 120 is an intermediary in the transaction between the financial institution system 160 (or issuer system 130) and the merchant system 150. For example, the payment processing system 120 deposits funds into a merchant system 150 account and then expects to receive payment from the financial institution system 160 associated with the user 101 financial account or from the issuer system 130 associated with the user 101 credit account. In other example embodiments, the payment processing system 120 does not credit the merchant system 150 account. In these example embodiments, the payment processing system 120 requests the credit authorization from the issuer system 130 on behalf of the merchant system 150 and the merchant system 150 expects to receive payment directly from the issuer system 130 and/or acquirer system 140 associated with the user 101 credit account or financial institution system 160 associated with the user 101 financial account.

In block 260, the payment processing system 120 initiates a bank transfer with the financial account system 160 associated with the user 101 financial account. In an example, the bank transfer is equal to the payment amount of the transaction. In another example, the bank transfer is equal to the payment amount of the transaction minus a minimal amount to be charged to a user 101 credit account if the bank transfer is successful. In an example embodiment, the payment processing system 120 transmits a transfer request via the Automated Clearing House (“ACH”). In an example embodiment, the transfer request comprises the user 101 financial account number, the name associated with the user 101 financial account, the routing number of the financial institution system 160 associated with the user 101 financial account, the payment amount, the date of the transaction, and/or other additional payment information. For example, additional payment information may comprise an invoice number or shipping information. If the payment processing system 120 deposited funds into a merchant system 150 financial account already, then the payment processing system 120 transfer request comprises information and instructions to enable the payment amount to be deposited in a payment processing system 120 financial account. For example, the payment processing system 120 provides the routing number, financial account number, and name associated with a payment processing system 120 financial account. In another example embodiment, the payment processing system 120 transfer request comprises information and instructions to enable the payment amount to be deposited in a merchant system 150 financial account. For example, the payment processing system 120 provides the routing number, financial account number, and name associated with a merchant system 150 financial account.

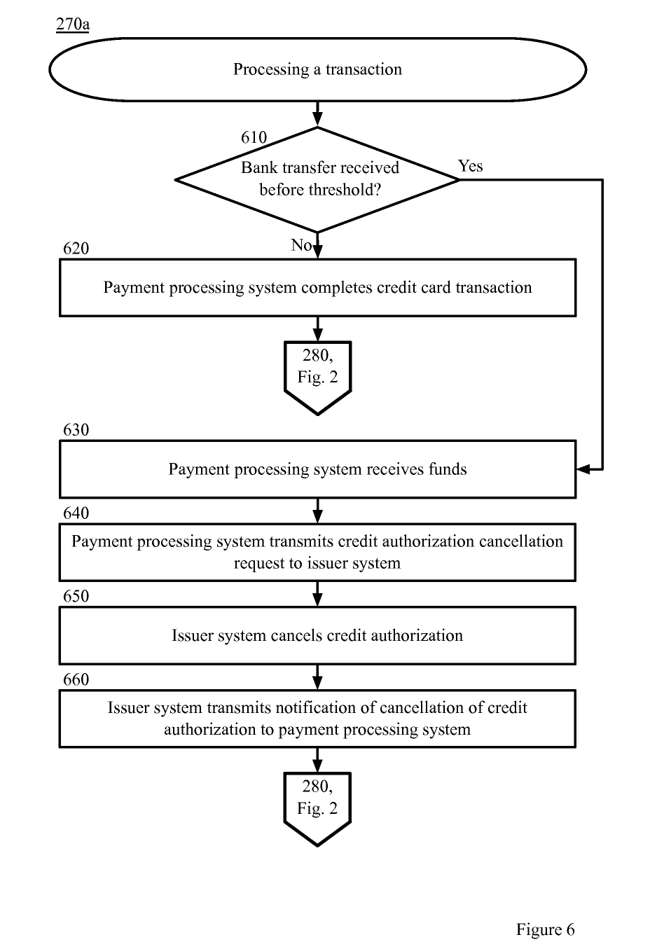

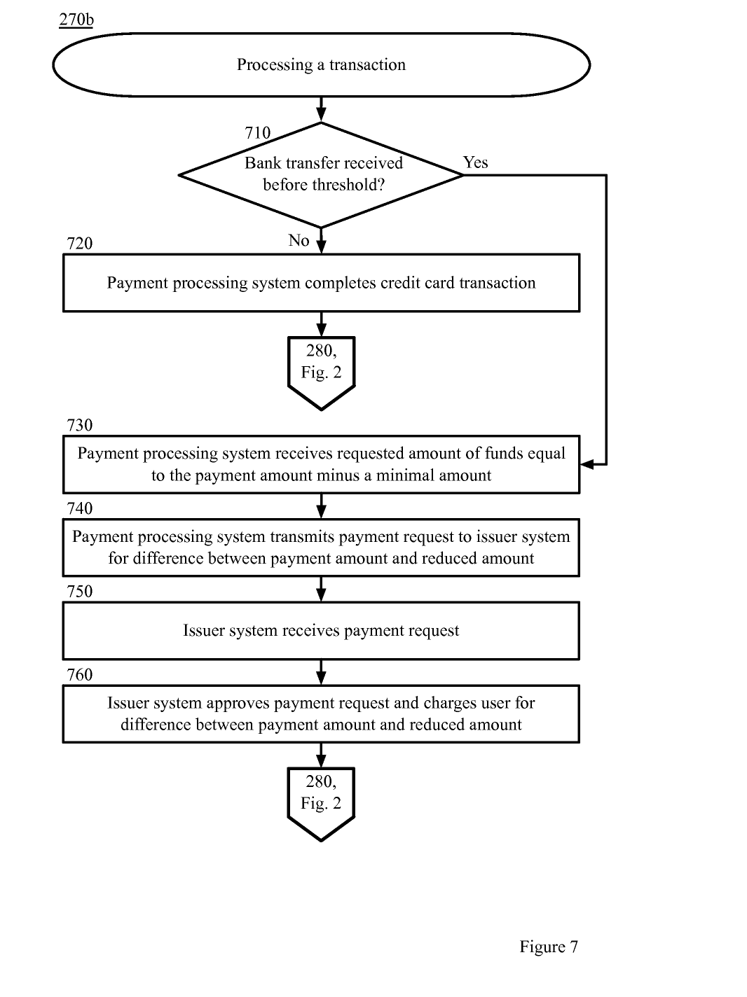

In block 270, the payment processing system 120 completes the transaction. The method for processing a transaction is described in more detail hereinafter with reference to the methods 270a, 270b described in FIGS. 6 and 7.

FIG. 6 is a block flow diagram depicting a method 270a for processing a transaction, in accordance with certain example embodiments, as referenced in block 270. The method 270a is described with reference to the components illustrated in FIG. 1.

In block 610, the payment processing system 120 determines whether a bank transfer has been received from the financial institution system 160 before a threshold amount of time has elapsed. For example, a bank transfer is not instantaneous and may require multiple days to process, therefore the payment processing system 120 may determine a threshold time limit after which the payment processing system 120 will charge the user's 101 credit account. For example, the threshold may be five days (120 hours) from the time the transfer is initiated by the payment processing system 120.

If the bank transfer is not received before the threshold, the method 270a proceeds to block 620. In another example embodiment, the bank transfer is unsuccessful, and the method 270a proceeds to block 620. For example, though the bank transfer is processed, the user 101 does not have enough funds to cover the payment amount of the transaction, therefore the payment processing system 120 completes the credit card transaction.

In block 620, the payment processing system 120 completes the credit card transaction. In an example embodiment, the payment processing system 120 sends a payment request to the acquirer system 140, which forwards the payment request to the issuer system 130. The issuer system 130 transmits funds equal to amount of the payment request through the acquirer system 140 to a payment processing system 120 financial account, and the issuer system 130 charges the payment amount to the user 101 account. In this example embodiment, the payment processing system 120, before completing the credit account transaction, credits the merchant system 150 financial account for the payment amount. In another example embodiment, the issuer system 130 transmits funds through the acquirer system 140 to a merchant system 150 account.

The method 270 then proceeds to block 280 in FIG. 2. In an example embodiment, the user 101 receives a receipt on the user computing device 110 for the credit account transaction. In an example embodiment, the user 101 receives a preliminary receipt at the time the credit authorization is approved and an updated receipt at the time the credit account transaction is completed. For example, the user 101 purchased product A from the merchant system 150, intending to pay a certain payment amount with the user 101 financial account. The user 101 receives a receipt for product A comprising the payment amount, the date of the transaction, the financial account identifier, and an estimated time frame in which the bank transfer will be processed. In this example, the payment processing system 120 or merchant system 150 does not receive the bank transfer and the user 101 credit account is charged. In this example, because the method of payment changed, the updated receipt may comprise the credit account identifier in addition to the payment amount and the date of transaction.

Returning to block 610, if the bank transfer is received before the threshold, the method 270 proceeds to block 630.

In block 630, the payment processing system 120 receives the requested funds. In this example embodiment, the requested amount of funds is equal to the payment amount of the transaction. In an example embodiment, the payment processing system 120 receives funds in a financial account associated with the payment processing system 120. In another example embodiment, the payment processing system 120 does not receive funds but is notified when the merchant system 150 receives funds in a merchant system 150 financial account. In an example bank transfer, the payment processing system 120 provides instructions to an originating depository financial institution (“ODFI”) to request a bank transfer from a user's 101 financial account to a merchant system 150 financial account or a payment processing system 120 financial account. In this example, the ODFI may be a financial institution system associated with the merchant system 150 financial account or payment processing system 120 financial account. In this example, the ODFI, via one or more automated clearing house (“ACH”) operators, transmits the instructions to request the bank transfer to a receiving depository financial institution (“RDFI”). In an example, the ACH operator is the Federal Reserve System or the Electronic Payments Network. In an example, the RDFI is the financial institution system 160 associated with the user 101 financial account. In this example, the financial institution system 160 (RDFI) validates the bank transfer request received from the ACH operator and debits funds from the user 101 financial account. In this example, the ACH operator debits funds associated with the bank transfer request from the financial institution system 160 (RDFI) and credits funds to the financial institution system (ODFI) associated with either the merchant system 150 financial account or payment processing system 120 financial account. In this example, the financial institution system associated with the merchant system 150 financial account or the financial institution system associated with the payment processing system 120 financial account posts a credit to the merchant system 150 account or payment processing system 120 account equal to the value of the bank transfer.

In block 640, the payment processing system 120 transmits a credit authorization cancellation request to the issuer system 130. In another example embodiment, the payment processing system 120 does not transmit a credit authorization cancellation request and the credit authorization expires. For example, the credit authorization expiration date may vary depending on policies set by the issuer system 130.

In block 650, the issuer system 130 cancels the credit authorization. In an example embodiment, the issuer system 130 charges the payment processing system 120 a fee for the credit authorization cancellation.

In block 660, the issuer system 130 transmits notification of cancellation of the credit authorization to the payment processing system 120. In an example embodiment, the payment processing system 120, the issuer system 130, and/or the acquirer system 140 notify the user 101 via the user computing device 110 of the cancellation of the credit authorization. From block 660, the method 270a returns to block 280 of FIG. 2.

Returning to FIG. 2, in block 280, the user 101 receives a receipt on the user computing device 110. In an example embodiment, the payment processing system 120 transmits the receipt. In another example embodiment, the financial institution system 160 or the merchant system 150 transmit the receipt. For example, the user 101 may receive a receipt or statement comprising a receipt on an application resident on the user computing device 110 that communicates with the financial institution system 160. In another example, the payment processing system 120 and/or merchant system 150 transmit a receipt to the user computing device 110. In an example embodiment, the receipt is received on the user computing device 110 via email, via text message, communication with an application resident on the user computing device 110, via the web browser 117, or by any other appropriate means of communicating the receipt to the user computing device 110. An example receipt comprises the payment amount, a financial account identifier or credit account identifier (for example, the last four digits of the financial account number or credit account number), the merchant name, the one or more products or services purchased, and the transaction date. In an example embodiment, the user 101 receives a receipt at the time the credit authorization is approved. In an example embodiment, the user 101 receives an updated receipt at the time that the payment processing system 120 or merchant system 150 receive the bank transfer from the user 101 financial account.

FIG. 7 is a block flow diagram depicting a method 270b for processing a transaction, in accordance with certain example embodiments, as referenced in block 270. The method 270b is described with reference to the components illustrated in FIG. 1.

In block 710, the payment processing system 120 determines whether a bank transfer has been received from the financial institution system 160 before a threshold amount of time has elapsed. For example, a bank transfer is not instantaneous and may require multiple days to process, therefore the payment processing system 120 may determine a threshold time limit after which the payment processing system 120 will charge the user's 101 credit account. For example, the threshold may be five days (120 hours) from the time the transfer is initiated by the payment processing system 120.

If the bank transfer is not received before the threshold, the method 270b proceeds to block 720.

In block 720, the payment processing system 120 completes the credit card transaction. In an example embodiment, the payment processing system 120 sends a payment request to the acquirer system 140, which forwards the payment request to the issuer system 130. The issuer system 130 transmits funds equal to amount of the payment request through the acquirer system 140 to a payment processing system 120 financial account, and the issuer system 130 charges the payment amount to the user 101 account. In this example embodiment, the payment processing system 120, before completing the credit account transaction, credits the merchant system 150 financial account for the payment amount. In another example embodiment, the issuer system 130 transmits funds through the acquirer system 140 to a merchant system 150 account.

The method 270 then proceeds to block 280 in FIG. 2. In an example embodiment, the user 101 receives a receipt on the user computing device 110 for the credit account transaction. In an example embodiment, the user 101 receives a preliminary receipt at the time the credit authorization is approved and an updated receipt at the time the credit account transaction is completed. For example, the user 101 purchased product A from the merchant system 150, intending to pay a certain payment amount with the user 101 financial account. The user 101 receives a receipt for product A comprising the payment amount, the date of the transaction, the financial account identifier, and an estimated time frame in which the bank transfer will be processed. In this example, the payment processing system 120 or merchant system 150 does not receive the bank transfer and the user 101 credit account is charged. In this example, because the method of payment changed, the updated receipt may comprise the credit account identifier in addition to the payment amount and the date of transaction.

Returning to block 710, if the bank transfer is received before the threshold, the method 270 proceeds to block 730.

In block 730, the payment processing system 120 receives the requested amount of funds equal to the payment amount minus a minimal amount. In this example, the minimal amount is charged to the user's 101 credit account so that the payment processing system 120 receives the full payment amount. In an example embodiment, the payment processing system 120 receives funds in a financial account associated with the payment processing system 120. In another example embodiment, the payment processing system 120 does not receive funds but is notified when the merchant system 150 receives funds in a merchant system 150 financial account. In an example bank transfer, the payment processing system 120 provides instructions to an originating depository financial institution (“ODFI”) to request a bank transfer from a user's 101 financial account to a merchant system 150 financial account or a payment processing system 120 financial account. In this example, the ODFI may be a financial institution system associated with the merchant system 150 financial account or payment processing system 120 financial account. In this example, the ODFI, via one or more automated clearing house (“ACH”) operators, transmits the instructions to request the bank transfer to a receiving depository financial institution (“RDFI”). In an example, the ACH operator is the Federal Reserve System or the Electronic Payments Network. In an example, the RDFI is the financial institution system 160 associated with the user 101 financial account. In this example, the financial institution system 160 (RDFI) validates the bank transfer request received from the ACH operator and debits funds from the user 101 financial account. In this example, the ACH operator debits funds associated with the bank transfer request from the financial institution system 160 (RDFI) and credits funds to the financial institution system (ODFI) associated with either the merchant system 150 financial account or payment processing system 120 financial account. In this example, the financial institution system associated with the merchant system 150 financial account or the financial institution system associated with the payment processing system 120 financial account posts a credit to the merchant system 150 account or payment processing system 120 account equal to the value of the bank transfer.

In block 740, the payment processing system 120 transmits a payment request to the issuer system 130 for a minimal amount. For example, the minimal amount may be the lowest allowed charge by the issuer system 130 for the user 101 credit account. In another example, the minimal amount may be a configured amount, for example, two dollars. In these examples, the minimal amount is the difference between the payment amount of the transaction and the amount of the successful bank transfer. In certain example embodiments, the issuer system 130 and/or acquirer system 140 maintain rules that a merchant system 150 may not initiate a credit authorization without the intent to charge the user 101 credit account. Intending to charge the minimal amount to the user 101 credit account pending a successful bank transfer gives the payment processing system 120 the ability to abide by the rules. In an example embodiment, the payment processing system 120 sends a payment request to the acquirer system 140 and the acquirer system 140 forwards the payment request to issuer system 130. In another example embodiment, the payment processing system 120 does not transmit a payment request for the minimal amount to the issuer system 130. In this example embodiment, the payment processing system 120 allows the original credit authorization to expire. In this example embodiment, after the payment processing system 120 receives funds from the bank transfer associated with the financial institution system 160, the transaction is complete.

In block 750, the issuer system 130 receives the payment request.

In block 760, the issuer system 130 approves the payment request and charges the user 101 for the minimal amount. The issuer system 130 transmits funds equal to amount of the payment request through the acquirer system 140 to a payment processing system 120 financial account, and the issuer system 130 charges the payment amount to the user 101 account. In this example embodiment, the payment processing system 120, before completing the credit account transaction, credits the merchant system 150 financial account for the payment amount. In another example embodiment, the issuer system 130 transmits funds through the acquirer system 140 to a merchant system 150 account. From block 760, the method 270b returns to block 280 of FIG. 2.

Returning to FIG. 2, in block 280, the user 101 receives a receipt on the user computing device 110. In an example embodiment, the payment processing system 120 transmits the receipt. In another example embodiment, the financial institution system 160 or the merchant system 150 transmit the receipt. For example, the user 101 may receive a receipt or statement comprising a receipt on an application resident on the user computing device 110 that communicates with the financial institution system 160. In another example, the payment processing system 120 and/or merchant system 150 transmit a receipt to the user computing device 110. In an example embodiment, the receipt is received on the user computing device 110 via email, via text message, communication with an application resident on the user computing device 110, via the web browser 117, or by any other appropriate means of communicating the receipt to the user computing device 110. An example receipt comprises the payment amount, a financial account identifier or credit account identifier (for example, the last four digits of the financial account number or credit account number), the merchant name, the one or more products or services purchased, and the transaction date. In an example embodiment, the user 101 receives a receipt at the time the credit authorization is approved. In an example embodiment, the user 101 receives an updated receipt at the time the payment processing system 120 or merchant system 150 receive the bank transfer from the user 101 financial account.

### Other Example Embodiments

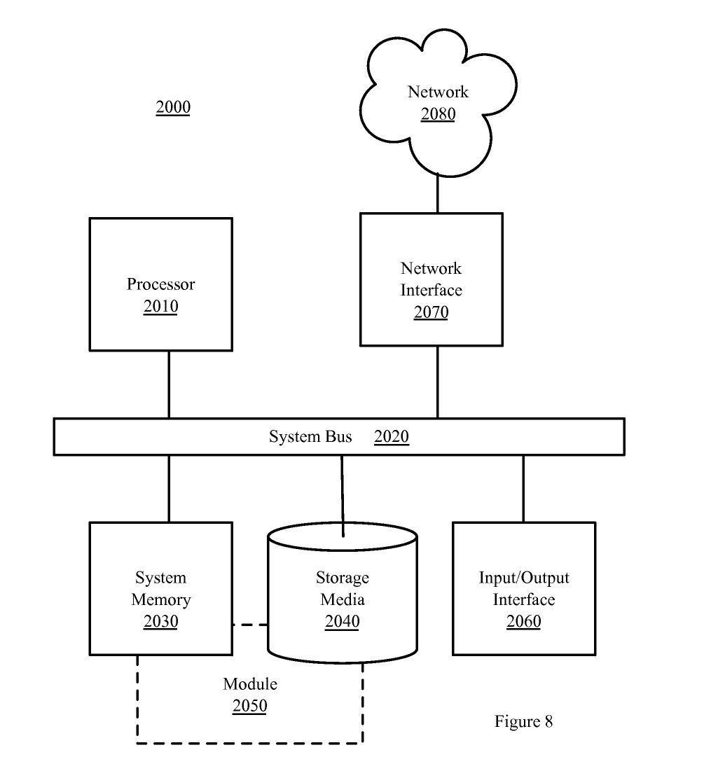

FIG. 8 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to use credit authorizations to guarantee alternate reimbursement from a user for a bank transfer transaction, comprising:
establishing, by one or more computing devices, a user record comprising financial account information associated with a financial account of a user and credit account information associated with a credit account of the user;
receiving, by one or more computing devices, a request for authorization for a transaction from a merchant system, the transaction being conducted between a user and a merchant system;
transmitting, by the one or more computing devices and to an issuer system associated with the credit account, a credit authorization request comprising a request to approve a charge to the credit account equal to an amount requested in the transaction authorization request;
receiving, by the one or more computing devices and from the issuer system, a credit authorization approval associated with the credit authorization request;
transmitting, by the one or more computing devices and to a financial account system associated with the financial account of the user, a bank transfer request comprising a request to transfer funds from the financial account of the user to an account associated with the one or more computing devices; and
transferring, by the one or more computing devices and to a financial account associated with the merchant system, funds in the amount of the transaction authorization request.

2. The method of claim 1, further comprising:
receiving, by the one or more computing devices, at a time after transmitting the bank transfer request, and from the financial account system, a bank transfer, wherein the bank transfer comprises funds equal to the amount requested in the transaction authorization request and wherein the funds are transferred from the financial account associated with the user to an account associated with the one or more computing devices;
transmitting, by the one or more computing devices and to the issuer system, a request to cancel the credit authorization, wherein the issuer system cancels the credit authorization.

3. The method of claim 1, further comprising:
at a time after transmitting the bank transfer request, receiving, by the one or more computing devices and from the financial account system, a bank transfer, wherein the bank transfer comprises funds equal to an amount requested in the transaction authorization request, and wherein the funds are transferred from the financial account of the user to an account associated with the one or more computing devices;
transmitting, by the one or more computing devices and to the issuer system, a payment request, wherein the payment request comprises a request for the issuer system to charge a reduced amount to the credit account associated with the user, and wherein the issuer system approves the payment request and charges the reduced amount to the credit account associated with the user; and
receiving, by the one or more computing devices and from the issuer system, the reduced amount, wherein the reduced amount is received in the account associated with the one or more computing devices.

4. The method of claim 1, further comprising:
at a threshold time after transmitting the bank transfer request and in response to not receiving a bank transfer from the financial account system within the threshold, transferring, by the one or more computing devices and to the issuer system, a payment request, wherein the payment request comprises a request for the issuer system to charge the amount requested in the transaction authorization request to the credit account associated with the user and wherein the issuer system approves the payment request and charges the amount to the credit account associated with the user; and
receiving, by the one or more computing devices and from the issuer system, the amount, wherein the amount is received in the account associated with the one or more computing devices.

5. The method of claim 1, wherein the user initiates the transaction with the merchant system via a user computing device.

6. The method of claim 5, wherein the user downloads an application associated with the payment processing system, wherein the application comprises information associated with the user account, and wherein the user initiates the transaction with the merchant system via the application operating on the user computing device.

7. The method of claim 1, wherein the user initiates the transaction with the merchant system via a merchant point of sale device.

8. A computer program product, comprising:
a non-transitory computer-readable medium having computer-executable program instructions embodied thereon that when executed by a computer cause the computer to use a credit authorization to guarantee a bank transfer transaction, the computer-executable program instructions comprising:
computer-executable program instructions for receiving a request for authorization for a transaction from a merchant system, the transaction being conducted between a user and a merchant system;
computer-executable program instructions for transmitting, to an issuer system associated with a credit account associated with the user, a credit authorization request comprising a request to approve a charge to the credit account equal to an amount requested in the transaction authorization request;
computer-executable program instructions for receiving, from the issuer system, a credit authorization approval associated with the credit authorization request;
computer-executable program instructions for transmitting, to a financial account system associated with a financial account of the user, a bank transfer request comprising a request to transfer funds from the financial account of the user to an account associated with the one or more computing devices; and
computer-executable program instructions for transferring, to a financial account associated with the merchant system, funds to conduct the transaction;

9. The computer program product of claim 8, further comprising, computer-executable program instructions for establishing a user account comprising financial account information associated with the financial account of the user and credit account information associated with the credit account of the user.

10. The computer program product of claim 8, further comprising:
computer-executable program instructions for receiving, at a time after transmitting the bank transfer request, from the financial account system, a bank transfer, wherein the bank transfer comprises funds equal to the amount requested in the transaction authorization request and wherein the funds are transferred from the financial account associated with the user to an account associated with the one or more computing devices;
computer-executable program instructions for transmitting, to the issuer system, a request to cancel the credit authorization, wherein the issuer system cancels the credit authorization.

11. The computer program product of claim 8, further comprising:
computer-executable program instructions for receiving, at a time after transmitting the bank transfer request, from the financial account system, a bank transfer, wherein the bank transfer comprises funds equal to the amount requested in the transaction authorization request and wherein the funds are transferred from the financial account associated with the user to an account associated with the one or more computing devices;
computer-executable program instructions for transferring, to the issuer system, a payment request, wherein the payment request comprises a request for the issuer system to charge a reduced amount to the credit account associated with the user and wherein the issuer system approves the payment request and charges the reduced amount to the credit account associated with the user; and
computer-executable program instructions for receiving, from the issuer system, the reduced amount, wherein the reduced amount is received in the account associated with the one or more computing devices.

12. The computer program product of claim 8, further comprising:
computer-executable program instructions for transferring to the issuer system, at a threshold time after transmitting the bank transfer request and in response to not receiving a bank transfer from the financial account system within the threshold, a payment request, wherein the payment request comprises a request for the issuer system to charge the amount requested in the transaction authorization request to the credit account associated with the user and wherein the issuer system approves the payment request and charges the payment amount to the credit account associated with the user; and
computer-executable program instructions for receiving, from the issuer system, the amount, wherein the amount is received in the account associated with the one or more computing devices.

13. The computer program product of claim 8, wherein the user initiates the transaction with the merchant system via a user computing device.

14. The computer program product of claim 13, wherein the user downloads an application associated with the payment processing system, wherein the application comprises information associated with the user account, and wherein the user initiates the transaction with the merchant system via the application operating on the user computing device.

15. The computer program product of claim 8, wherein the user initiates the transaction with the merchant system via a merchant point of sale device.

16. A system for using a credit authorization to guarantee a bank transfer transaction, comprising:
a storage device; and
a processor communicatively coupled to the storage device, wherein the processor executes application code instructions that are stored in the storage device to cause the system to:
receive, from a user, a request for authorization for a transaction from a merchant system, the transaction being conducted between a user and a merchant system;
transmit, to an issuer system associated with a credit account associated with the user, a credit authorization request comprising a request to approve a charge to the credit account equal to the amount requested in the transaction request;
receive, from the issuer system, a credit authorization approval associated with the credit authorization request;
transmit, to a financial account system associated with a financial account of the user, a bank transfer request comprising a request to transfer funds from the financial account of the user to an account associated with the one or more computing devices; and
transfer, to a financial account associated with the merchant system, funds to conduct the transaction.

17. The system of claim 16, wherein the processor is further configured to execute computer-executable program instructions stored in the storage medium to cause the system to transmit, to the issuer system, a request to cancel the credit authorization, wherein the issuer system cancels the credit authorization.

18. The system of claim 16, wherein the processor is further configured to execute computer-executable program instructions stored in the storage medium to cause the system to establish a user account comprising financial account information associated with the financial account of the user and credit account information associated with the credit account of the user.

19. The system of claim 16, wherein the processor is further configured to execute computer-executable program instructions stored in the storage medium to cause the system to:
receive, at a time after transmitting the bank transfer request, from the financial account system, a bank transfer, wherein the bank transfer comprises funds equal to the amount requested in the transaction authorization request and wherein the funds are transferred from the financial account of the user to an account associated with the one or more computing devices;
transfer, to the issuer system, a payment request, wherein the payment request comprises a request for the issuer system to charge a reduced amount to the credit account associated with the user and wherein the issuer system approves the payment request and charges the reduced amount to the credit account associated with the user; and
receive, from the issuer system, the reduced amount, wherein the reduced amount is received in the account associated with the one or more computing devices.

20. The system of claim 16, wherein the processor is further configured to execute computer-executable program instructions stored in the storage medium to cause the system to:
transfer, to the issuer system, at a threshold time after transmitting the bank transfer request and in response to not receiving a bank transfer from the financial account system within the threshold time, a payment request, wherein the payment request comprises a request for the issuer system to charge the amount requested in the transaction authorization request to the credit account associated with the user and wherein the issuer system approves the payment request and charges the amount to the credit account associated with the user; and
receive, from the issuer system, the amount, wherein the amount is received in the account associated with the one or more computing devices.
